(19) United States
(12) Patent Application Publication
(10) Pub. No.: US 2007/0008498 A1
(43) Pub. Date: Jan. 11, 2007

(54) Projection display device

(76) Inventors: Shohei Matsuoka, Tokyo (JP); Minoru Suzuki, Tochigi (JP)

Correspondence Address: PITNEY HARDIN LLP, 7 TIMES SQUARE, NEW YORK, NY, 10036-7311, US

(21) Appl. No.: 11/484,408

(22) Filed: Jul. 11, 2006

(30) Foreign Application Priority Data
Jul. 11, 2005 (JP) 2005-201412

(51) Int. Cl. G03B 21/22

(52) U.S. Cl. 353/78

(57) ABSTRACT

A projection display device is provided with a semi-transparent screen provided on a front surface of the projection display device, an image formation unit that emits light carrying an image to be projected on the screen, and a first reflector and a second reflector provided on an optical path between the image formation unit and the screen, the light emitted by the image formation unit being reflected by the second reflector and then by the first reflector before incident on the screen. The first reflector is arranged such that an angle formed between the first reflector and the screen is equal to or greater than 45 degrees and less than 90 degrees, and the second reflector is arranged such that an angle formed between the second reflector and the screen is an obtuse angle.

### BACKGROUND OF THE INVENTION

The present invention relates to a projection display device configured to project an image on a transmissive screen provided on a front surface of the device.

The projection display device is typically configured to include a light source, a transmissive image formation unit (e.g., a transmissive LCD) and an image forming optical system. Light from the light source is transmitted through the transmissive image formation unit, and using the image forming optical system, the image is projected on the screen light behind. The projected image is observed from the front side of the projection display device.

An example of such a projection display device is disclosed in Japanese Patent Provisional Publication No. P2003-287813A (hereinafter referred to as '813 publication). According to '813 publication, the light source and the image formation unit are arranged on lower rear position of the screen, and a second reflector (a relaying mirror), which is arranged to incline but close to parallel with respect to the screen, is provided below the screen. Further, on a rear side of the screen, a first reflector (final projection mirror), which is inclined such that an upper end is closer to the screen, is provided. Light from the light source transmits the image formation unit, is reflected by the second reflector and then first reflector. Then, the light is incident on the screen to form an image.

According to the above-described configuration, since the light is reflected multiple times, a sufficient optical path length to obtain a desired size of image can be realized with suppressing the depth of the projection display device. In other words, in comparison with the screen size, a relatively thin (i.e., having less depth) display device can be realized.

In the above configuration, however, since the second reflector and the light source are arranged on a lower side of the screen, a height of the entire device increases.

A configuration handling such a problem is disclosed in Japanese Patent Provisional Publication No. HEI 6-186498 (hereinafter, referred to as '498 publication). According to the configuration disclosed in '498 publication, the light source and the image formation unit are arranged on the lower portion of the device, and the light is reflected by reflectors, which are arranged on an upper surface and rear panel. According to this structure, the light proceeds to turn around the rear portion, the upper portion and the front portion of the device. That is, the light source, image formation unit and the image formation optical system are arranged on the rear side of the screen, and the necessary optical path length can be obtained. Therefore, both the depth and height of the device can be suppressed.

However, according to the above configuration of '813 publication or '498 publication, since a reflector is arranged to be almost parallel to the screen, if there is an external light source in front of the device (e.g., at a high position behind an observer of the screen), light from the external light source may pass the screen and be incident on the reflector provided on the rear panel, and then reflected by the reflector on the rear panel and be directed to the observer through the screen, which obstacles the observation of the image. Further, according to the above configurations, light forming the image is reflected inside the device may be reflected by the rear surface of the screen, reflected by other reflectors and incident on the screen again. In such a case, a so-called ghost phenomenon occurs (i.e., the image is displayed as blurred).

Such a problem is handled in Japanese Patent Provisional Publications No. P2002-207190A (hereinafter, referred to as '190 publication) or No. HEI 5-88264 (hereinafter, referred to as a '264 publication). The device disclosed in '190 publication is configured such that the light passed through the image formation unit is directly introduced to a reflector provided on the upper surface of a casing of the device. In this device, the ghost phenomenon can be avoided. however, the image formation unit should be provided behind the reflector. Therefore, in comparison with the structure of '813 publication, the depth of the device is increased.

According to the configuration shown in '264 publication, the reflector is oriented to form an acute angle with respect to the screen in addition to a configuration similar to that of '190 publication. In this configuration, the longer the optical path length from the image formation unit to the screen is, the shorter the length in depth direction from the screen to the reflector is. However, if the optical length from the image formation unit to the screen is longer, the light source and the image formation unit should be provided at position largely shifted downward with respect to the lower end of the screen. Therefore, the height of the projection display device becomes large according to this configuration.

### SUMMARY OF THE INVENTION

Aspects of the invention provide a projection display device of which the height and depth are suppressed and can prevent a problem of reflecting light from an external light source inside the device and/or ghost phenomenon.

According to aspects of the invention, there is provided a projection display device, which is provided with a semi-transparent screen provided on a front surface of the projection display device, an image formation unit that emits light carrying an image to be projected on the screen, and a first reflector and a second reflector provided on an optical path between the image formation unit and the screen, the light emitted by the image formation unit being reflected by the second reflector and then by the first reflector before incident on the screen. The first reflector is arranged such that an angle formed between the first reflector and the screen is equal to or greater than 45 degrees and less than 90 degrees, and the second reflector is arranged such that an angle formed between the second reflector and the screen is an obtuse angle.

A distance between the screen and a position on the first reflector, on which a ray having a minimum incident angle with respect to the screen among rays of light reflected by the first reflector and directed to the screen is incident, may be equal to or less than half a distance between the screen and another position on the first reflector, on which a ray having a maximum incident angle with respect to the screen among rays of light reflected by the first reflector and directed to the screen.

An end of the first reflector may substantially contact an end of the screen.

A relationship as follows may be satisfied.

That is,
45°−w2/2≦θ≦45°−w1/2,

where, θ denotes an angle formed between the first reflector and a normal to the screen, w1 denotes an angle formed between the normal to the screen and a line segment that is a projection of a ray having a minimum incident angle with respect to the screen among rays of light directed from the first reflector to the screen on a plane perpendicular to both the screen and the first reflector, and w2 denotes an angle formed between the normal to the screen and a line segment that is a projection of a ray having a maximum incident angle with respect to the screen among rays of light directed from the first reflector to the screen on a plane perpendicular to both the screen and the first reflector.

The angles θ, w1 and w2 may be within ranges defined below, respectively:
0°≦θ≦40°;
0°≦w1≦60°; and
60°≦w2≦85°.

The angles θ, w1 and w2 may have a following relationship:
sin(2θ+w2−90°)≦(tan w2·cos(2θ+w1)+sin(2θ+w2−90°)·sin(w2−w1)/sin(2θ+w1+w2).

According to other aspects, there is provided a projection display device, which is provided with a semi-transparent screen provided on a front surface of the projection display device, an image formation unit that emits light carrying an image to be projected on the screen, and a reflecting unit arranged on an optical path between the image formation unit and the screen to reflect the image emitted by the image formation unit in a predetermined direction. The reflecting unit may be arranged such that an angle formed between a reflecting surface of the reflecting unit and the screen is equal to or greater than 45 degrees and less than 90 degrees, and a relationship below may be satisfied.
45°−w2/2≦θ≦45°−w1/2

where, θ denotes an angle formed between the reflecting surface of the reflecting unit and a normal to the screen, w1 denotes an angle formed between the normal to the screen and a line segment that is a projection of a ray having a minimum incident angle with respect to the screen among rays of light directed from the reflecting unit to the screen on a plane perpendicular to both the screen and the reflection surface of the reflecting unit, and w2 denotes an angle formed between the normal to the screen and a line segment that is a projection of a ray having a maximum incident angle with respect to the screen among rays of light directed from the reflecting unit to the screen on a plane perpendicular to both the screen and the reflecting surface of the reflecting unit.

The angles θ, w1 and w2 may be within ranges defined below, respectively:
0°≦θ≦40°;
0°≦w1≦60°; and
50°≦w2≦85°.

### BRIEF DESCRIPTION OF THE ACCOMPANYING DRAWINGS

FIG. 1 is a cross sectional view of a projection display device taken along a plane perpendicular to a screen thereof and parallel with a vertical direction.

FIG. 2 is an enlarged cross sectional view of a screen taken along a plane perpendicular to the screen and parallel with the vertical direction.

FIG. 3 is a cross sectional view of the screen, a relaying mirror and a final projection mirror taken along a plane perpendicular to the screen and parallel with the vertical direction.

FIG. 4 is a cross sectional view of the screen, a relaying mirror and a final projection mirror taken along a plane perpendicular to the screen and parallel with the vertical direction.

### DETAILED DESCRIPTION OF THE EMBODIMENTS

Hereinafter, referring to the accompanying drawings, scanning lenses according to embodiments of the invention will be described.

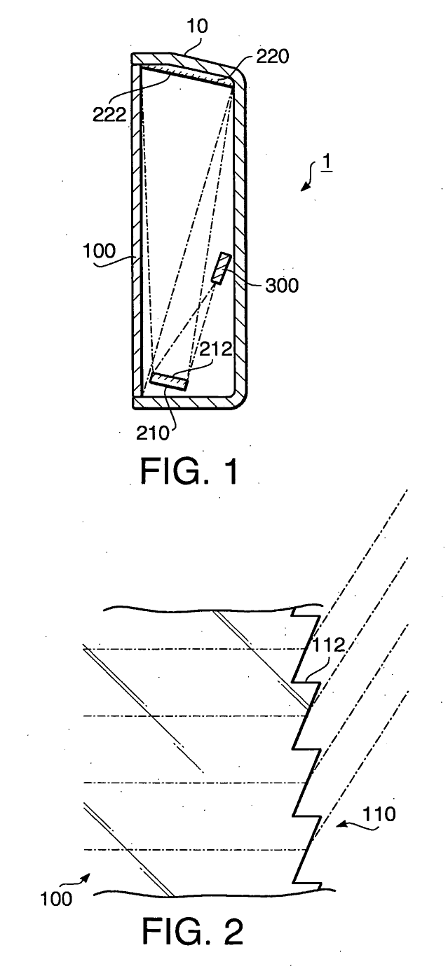

FIG. 1 is a cross-sectional view of a projection display device 1 taken along a plane perpendicular to a screen of the projection display device 1 and parallel with a vertical direction (hereinafter, referred to as a vertical plane) according to aspects of the invention. The projection display device 1 has a casing 10 which has a relatively short depth in comparison with its width and height. On a front surface of the casing 10, a screen 100 for displaying an image is provided. Specifically, the screen 100 is made of semi-transparent material. An image is projected onto the screen 100 from behind (i.e., inside the casing 10), and the projected image is observed from the front side. For this purpose, optical compositions for displaying images on the screen 100 are provided inside the casing 10.

Inside the casing 10, a projection unit 300 is accommodated. The projection unit 300 includes an LCP (Liquid Crystal Panel) for forming an image, a light source configured to emit light to pass through the LCP, and an image forming optical system that converges the light passed through the LCP on the screen 100 to form an in-focus image thereon. As shown in FIG. 1, the projection unit 300 is arranged on a rear portion inside the casing 10 at a substantially central position in the height direction. The light passed through the LCP and emitted from the projection unit 300 is incident on a relaying mirror 210 arranged at a front lower position inside the casing 10.

The relaying mirror 210 is inclined such that a front edge thereof is slightly higher than a horizontal plane, with its reflecting surface 212 located upward. The light emitted from the projection unit 300 is reflected by the reflecting surface 212 and incident on a final projection mirror 220 arranged at inner top position inside the casing 10.

Specifically, the final projection mirror 220 is adhered to an inner surface of the top board of the casing 10. A reflecting surface 222 is formed on an lower surface of the final projection mirror 220. An front edge of the final projection mirror 220 contacts an upper edge of the screen 100. The final projection mirror 220 is inclined such that the front edge is slightly higher than its rear edge with respect to the horizontal plane, as shown in FIG. 1. The light reflected by the relaying mirror 21 and incident on the final projection mirror 220 is reflected by the reflecting surface 222 and incident on the screen 100. The screen is made of semi-transparent material, and thus the image projected to the screen 100 from behind can be observed from the front side of the screen 100. It should be noted that the upper end of the final projection mirror 220 is cut to have a surface extending horizontally. The height of the upper end of the projection display device 1 is suppressed to be substantially equal to the height of the screen 100 and the thickness of the casing 10.

In FIG. 1, an optical path of light emitted from the projection unit 300, a range in which light rays proceed from the projecting unit 300 to the screen 100 via the relaying mirror 210 and the final projection mirror 220 is indicated by dotted lines. As indicated in FIG. 1, according to the present embodiment, the light reflected by the final projection mirror 220 is incident on the screen 110 such that any ray of the light is incident on the screen 100 at an incident angle greater than 45 degrees. Therefore, on an inner surface of the screen 100, a reflecting structure that reflects the light incident thereon so that the light emerges from the outer surface of the screen 100 substantially horizontally.

The reflecting structure will be described in detail with reference to FIG. 2, which is an enlarged partial cross-sectional side view of the screen 100, taken along the vertical plane perpendicular to the screen 100. As shown in FIG. 2, on the inner surface 110 of the screen 100, a plurality of protrusions 112 each having a saw-tooth cross section are formed. The light incident on inclined surfaces (i.e., right-hand side surfaces in FIG. 2) of the protrusions 112 is reflected to proceed substantially horizontally as indicated by dotted lines, and emerge from the outer surface (i.e., left-hand side surface) of the screen 100. In other words, the reflecting structure functions as a kind of Fresnel lens.

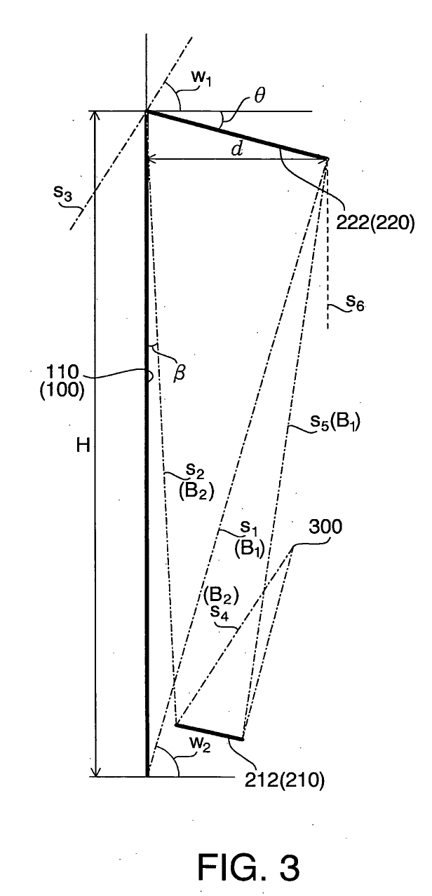

FIG. 3 illustrates the arrangement of the relaying mirror 210 and the final projection mirror 220 of the projection device 1 according to the present invention. Specifically, FIG. 3 schematically shows a cross-section of the projection device 1 taken along the vertical plane perpendicular to the screen 100. In FIG. 3, for brevity, only the inner surface 110 of the screen 100, reflection surfaces 212 and 222 of the relaying mirror 210 and the final projection mirror 220 are shown, and the screen 100, relaying mirror 210 and final projection mirror 22 are omitted. Further, the projection unit 300 is represented by a dot.

In the following description, an angle formed between the reflection surface 222 of the final projection mirror 220 and normal to the screen 100 is represented by θ. Further, a line that is defined as a projection of a ray, which is incident on the screen 100 at a smaller incident angle than any other rays emitted by the projection unit 300, on a vertical plane perpendicular to the screen 100 is defined as lines B1, and a line that is defined as a projection of a ray, which is incident on the screen 100 at a maximum incident angle than any other rays emitted by the projecting unit 300, on the vertical plane perpendicular to the screen 100 is defined as lines B2. Among multiple lines B1, a line segment directed from the final projection mirror 220 to the screen is represented by s1, and a line segment directed from the relaying mirror 210 to the final projection mirror 220 is represented by s5. Among multiple rays B2, a line segment directed from the relaying mirror 210 to the final projection mirror 220 is represented by s2, and a line extending a line segment directed from the final projection mirror 220 to the screen 100 is represented by s3. It should be noted that, if the line segment s2 is reversed with respect to the normal to the final projection mirror 220, the reversed line segment s2 overlaps the line s3.

In FIG. 3, w1 represents an angle formed between the line s3 and the normal to the screen 100, w2 represents an angle formed between the line segment s1 and the normal to the screen 100, H represent the height of the screen 100, L represents the length of the line B2 (i.e., sum of the line segments s2 and s4), and d represents a distance from the rear edge of the final projection mirror 220 to the inner surface 110 of the screen 100. In the following description, the size of the projection unit 300 and the thicknesses of the relaying mirror 210 and the final projection mirror 220 are considerably smaller than the size of the projection display device 1.

The distance d can be calculated by equation (1) below, using the height H, angles θ, w1 and w2.

$$d = \frac{H}{tan W 2 + tan θ} \qquad ( 1 )$$

In order to reduce the thickness d down to substantially a half of the shorter side of the screen 100, in consideration of the thickness of a mechanism for attaching the relaying mirror 210, it is preferable that w2 is equal to 50 degrees or more. Regarding the upper limit, if the w2 is close to 90 degrees, the ray directed from the relaying mirror 210 to the final projection mirror 220 is too close to the inner surface 110 of the screen. Therefore, practically, the upper limit of w2 is approximately 85 degrees.

Regarding the angle w1, in order to avoid bad effects such as scattering as the mechanisms inside the device 1 and edge portion of the final projection mirror 220 are located on the normal to the center of the screen, the angle w1 may be slightly larger than the theoretical value thereof, and may be 60 degrees or less practically. It should be noted that angle w2 is greater than angle w1 (w2>w1).

Therefore, under a condition where the projection unit 300 and/or the relaying mirror 210 does not exceeds the positions of the upper/lower ends of the screen 100, in order to reduce the depth of the projection display device 1, a maximum angle θ is determined, at which angle, the angles w1 and w2 satisfy the above condition, the projection unit 300 is arranged on a rear side of the screen 100, each of a distance between the projection unit 300 and the screen 100 and a distance between the projection unit 300 and the rear end of the relaying mirror 210 is smaller than the distance d (i.e., the projection unit 300 and the relaying mirror 210 are arranged between the screen 100 and a plane parallel to the screen 100 and passing the rear end of the final projection mirror 220), and the rear end of the relaying mirror 210 is not located at a position higher than the upper end of the screen 100.

In order to avoid interference between the relaying mirror 210 and the screen 100, an angle β formed between the inner surface 110 and the line segment s2 should be 0° or more. Since the angle β is calculated as 90°−2θ−w1. Since β should be 0° or more, conditional expression (2) below should be satisfied.

$$θ \leq {45}^{∘} - \frac{w 1}{2} \qquad ( 2 )$$

In order to make the distance between the rear end of the relaying mirror 210 and the screen 100 is smaller than the distance d, a line directed from the rear end of the reflection surface 212 of the relaying mirror 210 to the rear end of the reflection surface 222 of the final projection mirror 220 (i.e., dotted line s5 in FIG. 3) and a vertical line passing the rear end of the reflection surface 222 (i.e., broken line s6) form an angle of 0° or larger. This angle is represented by 2θ+w2−90°. Therefore, in order to maintain this angle (i.e., the angle formed between line segments s5 and s6) equal to or greater than 0°, the angle θ should satisfy conditional expression (3).

$$θ \geq {45}^{∘} - \frac{w 2}{2} \qquad ( 3 )$$

From the conditional expression (2), it is obvious that θ is equal to or less than 45°. In other words, an angle formed between the screen 100 and the final projection mirror 220 (i.e., 90°−θ) is equal to or greater than 45° and equal to or less than 90°. When the angle formed between the screen 100 and the final projection mirror 220 meets the above condition, it is possible to prevent phenomenon that light from an external light source arrange outside the projection display device 1 (in particular, arranged at a rear and above position of the viewer) is incident on the screen 100, passing therethrough and incident on the final projection mirror 220, reflected thereby and incident on the viewer's eyes through the screen 100 (thereby the viewer feels difficulty in viewing the images) and a ghost phenomenon which occurs as the light incident on the screen 100 from its behind is reflected by the screen and then reflected back to the screen by the final projection mirror.

If L cos β≦H in this case, it is possible to provide the projection unit 300 inside the casing 10 of the projection display device without providing the relaying mirror 210. Here, L is expressed by equation (4) below using H, θ, w1 and w2.

$$L = \frac{H}{cos w 1 ( tan w 2 - tan w 1 )} \qquad ( 4 )$$

Therefore, when condition (5) below is satisfied, the relaying mirror 210 becomes unnecessary. Further, when all the conditions 2, 3 and 5 are satisfied, a compact projection display device in which the projection unit 300 does not protrude rearward with respect to the rear end of the final projection mirror or downward with respect to the lower end of the screen 100, and no relaying mirror is required can be realized. For example, when H=747 mm, w1=19.9°, w2=53°, if θ=22.6°, the conditions 2, 3 and 5 are all satisfied, and d=428 mm.
sin(2θ+w1)≦cosw1·tanw2−sinw1 (5)

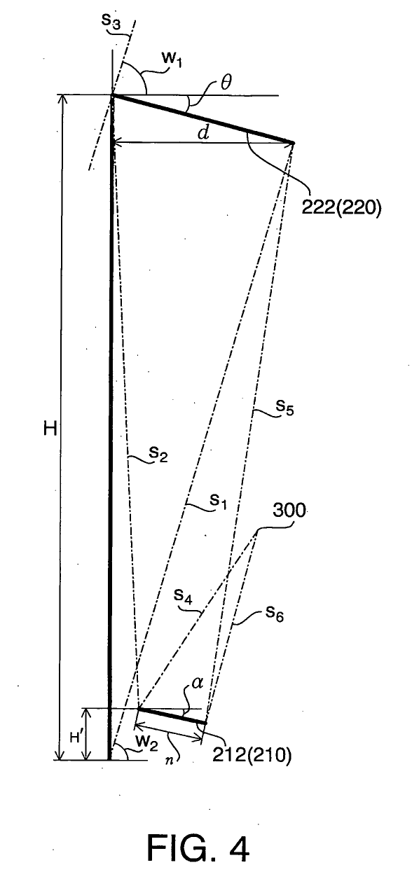

Next, a condition required when the relaying mirror 210 is completely accommodated in the casing 10 will be described, referring to FIG. 4. FIG. 4 is a cross-sectional side view of the screen 100, relating mirror 210 and the final projection mirror 220 taken along the vertical plane perpendicular to the screen.

In FIG. 4, α represents an angle formed between a cross section of the reflection surface 212 on the vertical plane perpendicular to the screen 100 and the normal to the screen 100. Further, n represent a length of the reflection surface 212 on the vertical plane. In order to arrange the rear end of the relaying mirror 210 at a level equal to or higher than the lower end of the screen 100, a relationship expressed by condition (6) should be satisfied between a distance H′, which is a length from a normal to the screen 100 that intersects with front end of the relaying mirror 210 and the lower end of the screen 100, the length n and the angle α. In the following explanation, it is assumed that the front end of the relaying mirror 210 is located at the intersection between the line segments s1 and s2. When the relaying mirror 210 is arranged such that the angle formed between the reflection surface 212 and the screen 100 is an obtuse angle, the projection unit 300 can be arranged in a dead space between the relaying mirror 210 and the final projection mirror 220, and downsizing of the projection displaying device becomes possible.
n sin α≦H′ (6)

The angle α is minimized when the reflection surface 212 is perpendicular to the line segment s5, and at that time, the value of n·sin α is also minimized. When the reflection surface 212 is perpendicular to the line segment s5, the angle α is 2θ+w2−90°. Further, the rear end of the relaying mirror 210 is the farthest from the lower end of the screen 100, and the projection unit 300 is arranged on the line segment s5. If the angle α becomes smaller, the projection unit 300 moves upward. Therefore, in order to avoid a situation that the projection unit 300 is arranged rearward with respect to the final projection mirror 220 and the depth of the projection display device 1, it is preferable that the angle α is equal to 2θ+w2−90°. The following description is made assuming that the angle α has the above value.

The length H′ can be expressed by equation (7) below using the angles θ, w1 and w2.

$${H}^{′} = \frac{H tan ( {90}^{∘} - 2 θ - w 1 )}{tan ( {90}^{∘} - w 2 ) + tan ( {90}^{∘} - 2 θ - w 1 )} \qquad ( 7 )$$

Here, a length of a line segment (s2) that is a projection of a ray directed from the front end of the relaying mirror 210 to the front end of the final projection mirror 220 on a vertical plane perpendicular to the screen 100 will be represented by L′. According to this definition, the length of a line segment (s2) that is a projection of a ray directed from the projecting unit 300 to the front end of the relaying mirror 210 on the vertical plane perpendicular to the screen 100 is represented by L−L′. The value L′ can be calculated by equation (8).

$${L}^{′} = \frac{H - {H}^{′}}{cos ( {90}^{∘} - 2 θ - w 1 )} \qquad ( 8 )$$

Further, from conditions (7) and equation (8), equation 9 can be obtained.

$${L}^{′} = \frac{H tan ( {90}^{∘} - w 2 )}{( tan ( {90}^{∘} - w 2 ) + tan ( {90}^{∘} - 2 θ - w 1 ) ) cos ( {90}^{∘} - 2 θ - w 1 )} \qquad ( 9 )$$

Further, an angle formed between a line segment (s6) that is a projection of a ray directed from the projecting unit 300 to the rear end of the relaying mirror 210 on the vertical plane perpendicular to the screen 100 is expressed as w2−w1. Since α=2θ+w2−90°, the line segment s6 is perpendicular to the reflection surface 212, and the size n thereof satisfies condition (10) below.
n=(L−L′)sin(w2−w1) (10)

From equations (9) and (10), n is defined by equation (11) below.

$$n = [ L - \frac{H tan ( {90}^{∘} - w 2 )}{( tan ( {90}^{∘} - w 2 ) + tan ( {90}^{∘} - 2 θ - w 1 ) ) cos ( {90}^{∘} - 2 θ - w 1 )} ] sin ( w 2 - w 1 ) \qquad ( 11 )$$

From equations (6) and (7)m a range of the value n is defined to satisfy condition (12) below.

$$n sin ( 2 θ + w 2 - {90}^{∘} ) \leq \frac{H tan ( {90}^{∘} - 2 θ - w 1 )}{tan ( {90}^{∘} - w 2 ) + tan ( {90}^{∘} - 2 θ - w 1 )} \qquad ( 12 )$$

Further, equations (4), (11) and (12), a relationship (13) is derived.

$$sin ( 2 θ + w 2 - {90}^{∘} ) \leq \frac{\begin{matrix}tan w 2 \cdot cos ( 2 θ + w 1 ) + \\ sin ( 2 θ + w 2 - {90}^{°} ) \cdot sin ( w 2 - w 1 )\end{matrix}}{sin ( 2 θ + w 1 + w 2 )} \qquad ( 13 )$$

By determining the value of θ to satisfy the relationship (13) within a range where the equations (2) and (3) are valid, the projecting unit 300 is arranged on the rear side of the screen 100, the distance from the projecting unit 300 to the screen 100 and to the rear end of the relaying mirror 210 can be smaller than the distance d, and the rear end of the relaying mirror 210 does not protrude upward from the upper end of the screen.

For example, when H=747 mm, w1=19.9° and w2=50°, by making θ=32.9°, conditions (2), (3) and (13) are satisfied, and d=406 mm. If θ is larger, a difference between the left term and the right term of the relationship (13) is smaller. Therefore, if it is possible to set the value of θ such that the left term equals the right term in the relationship (13), the angle θ at that time minimizes the distance d (i.e., the depth of the projection display device 1).

In the illustrative embodiment, the relaying mirror 210 is configured to reflect the light from the projection unit 300 arranged on the upper rear side of the relaying mirror 210 to the upper front side. It should be noted that the present invention needs not be limited to the above configuration. For example, a configuration where the projection unit 300 and the relaying mirror 210 are arranged at lower end portions, in the width direction, of the projection display device 1, respectively, and the relaying mirror 210 reflects the light that is directed to the relaying mirror along an optical path extending in the width direction of the projection display device 1.

The present disclosure relates to the subject matter contained in Japanese Patent Application No. 2005-201412, filed on Jul. 11, 2005, which is expressly incorporated herein by reference in its entirety.

What is claimed is:

1. A projection display device, comprising:
a semi-transparent screen provided on a front surface of the projection display device;
an image formation unit that emits light carrying an image to be projected on the screen; and
a first reflector and a second reflector provided on an optical path between the image formation unit and the screen, the light emitted by the image formation unit being reflected by the second reflector and then by the first reflector before incident on the screen,
wherein the first reflector is arranged such that an angle formed between the first reflector and the screen is equal to or greater than 45 degrees and less than 90 degrees, and
wherein the second reflector is arranged such that an angle formed between the second reflector and the screen is an obtuse angle.

2. The projection display device according to claim 1,
wherein a distance between the screen and a position on the first reflector, on which a ray having a minimum incident angle with respect to the screen among rays of light reflected by the first reflector and directed to the screen is incident, is equal to or less than half a distance between the screen and another position on the first reflector, on which a ray having a maximum incident angle with respect to the screen among rays of light reflected by the first reflector and directed to the screen.

3. The projection display device according to claim 2,
wherein an end of the first reflector substantially contact an end of the screen.

4. The projection display device according to claim 1,
wherein a relationship,
45°−w2/2≦θ≦45°−w1/2,
where, θ denotes an angle formed between the first reflector and a normal to the screen, w1 denotes an angle formed between the normal to the screen and a line segment that is a projection of a ray having a minimum incident angle with respect to the screen among rays of light directed from the first reflector to the screen on a plane perpendicular to both the screen and the first reflector, and w2 denotes an angle formed between the normal to the screen and a line segment that is a projection of a ray having a maximum incident angle with respect to the screen among rays of light directed from the first reflector to the screen on a plane perpendicular to both the screen and the first reflector,
is satisfied.

5. The projection display device according to claim 4, where the angles θ, w1 and w2 have a following relationship:
sin(2θ+w2−90°)≦(tan w2·cos(2θ+w1)+sin(2θ+w2−90°)·sin(w2−w1)/sin(2θ+w1+w2).

6. The projection display device according to claim 4,
wherein the angles θ, w1 and w2 are within ranges defined below, respectively:
0°≦θ≦40°;
0°≦w1≦60°; and
60°≦w2≦85°.

7. The projection display device according to claim 4, where the angles θ, w1 and w2 have a following relationship:
sin(2θ+w2−90°)=(tan w2·cos(2θ+w1)+sin(2θ+w2−90°)·sin(w2−w1)/sin(2θ+w1+w2).

8. A projection display device, comprising:
a semi-transparent screen provided on a front surface of the projection display device;
an image formation unit that emits light carrying an image to be projected on the screen; and
a reflecting unit arranged on an optical path between the image formation unit and the screen to reflect the image emitted by the image formation unit in a predetermined direction,
wherein the reflecting unit is arranged such that an angle formed between a reflecting surface of the reflecting unit and the screen is equal to or greater than 45 degrees and less than 90 degrees, and
wherein a relationship,
45°−w2/2≦θ≦45°−w1/2,
where, θ denotes an angle formed between the reflecting surface of the reflecting unit and a normal to the screen, w1 denotes an angle formed between the normal to the screen and a line segment that is a projection of a ray having a minimum incident angle with respect to the screen among rays of light directed from the reflecting unit to the screen on a plane perpendicular to both the screen and the reflection surface of the reflecting unit, and w2 denotes an angle formed between the normal to the screen and a line segment that is a projection of a ray having a maximum incident angle with respect to the screen among rays of light directed from the reflecting unit to the screen on a plane perpendicular to both the screen and the reflecting surface of the reflecting unit,
is satisfied.

9. The projection display device according to claim 8,
wherein the angles θ, w1 and w2 are within ranges defined below, respectively:
0°≦θ≦40°;
0°≦w1≦60°; and
50°≦w2≦85°.
